(19) United States
(12) Patent Application Publication
(10) Pub. No.: US 2012/0215627 A1
(43) Pub. Date: Aug. 23, 2012

(54) SYSTEM, METHOD AND COMPUTER READABLE RECORDING MEDIUM FOR CHARGING FOR ON-LINE ADVERTISEMENT

(75) Inventors: Youn Sik LEE, Seongnam-si (KR); Dong Wook KIM, Seongnam-si (KR); Yu Won KIM, Seongnam-si (KR); Jung Soo HA, Seongnam-si (KR); Won Sook NOH, Seongnam-si (KR)

(73) Assignee: NHN CORPORATION, Seongnam-si (KR)

(21) Appl. No.: 13/217,067

(22) Filed: Aug. 24, 2011

(30) Foreign Application Priority Data
Aug. 25, 2010 (KR) 10-2010-0082252

(51) Int. Cl. G06Q 30/02

(52) U.S. Cl. 705/14.45

(57) ABSTRACT

A computer-implemented charging control method includes determining an expected click count for an advertisement provided on a web page; obtaining a generated click count for the advertisement, using the computer, the generated click count including a number of clicks on the advertisement during a period of time; generating an invoice for the advertisement, based on the expected click count and the generated click count; and transmitting the invoice to an advertiser terminal.

### CROSS-REFERENCE TO RELATED APPLICATIONS

This application claims priority from and the benefit of Korean Patent Application No. 10-2010-0082252, filed on Aug. 25, 2010, which is hereby incorporated by reference for all purposes as if fully set forth herein.

### BACKGROUND OF THE INVENTION

1. Field of the Invention

Exemplary embodiments of the present invention relate to a system, a method, and a computer readable recording medium for charging for an on-line advertisement.

2. Discussion of the Background

Among several methods for charging for an online advertisement, cost per click (CPC) model has been widely used. In the CPC model, charging is performed based on the number of clicks (click counts) on provided advertisement listings.

However, the charging may not be made for every click on provided advertisements, and a process of excluding invalid click counts (“invalid clicks”) from observed click counts (OCC) is generally performed. A calculation of invalid click counts and the elimination of the invalid click counts when for charging an online advertisement may be used as an effective method for preventing an improper charging based on excessive invalid click counts in a keyword search advertisement. Invalid clicks may be detected by a search advertisement providing system providing a search advertisement. A process of detecting the invalid clicks performed by the search advertisement providing system is not generally disclosed to an advertiser because the publication of an invalid click detecting algorithm causes the search advertisement providing system to be vulnerable to click manipulation.

Due to the non-publication of the invalid click detecting process, however, the advertiser may doubt whether the click count reported as a basis of the charging in an advertisement system is properly calculated. For example, the advertiser may doubt whether the calculation method used for calculating the click count is proper. Further, the advertiser may doubt whether invalid clicks, which may decrease his advertisement balance, have been excluded from the click count reported by the advertisement system. Furthermore, even though data provision and public relations for the advertisement system may be conducted by the advertisement system provider, in order to prove that the click counts are calculated using proper calculation algorithm in the advertisement system, such actions may be insufficient to overcome the doubts of the advertiser.

Therefore, there is a demand for an advertisement charging technology to address the above-mentioned problems and to satisfy both the advertiser and the advertisement system provider, without disclosing the invalid click detecting algorithm.

### SUMMARY OF THE INVENTION

Exemplary embodiments of the present invention provide a system, a method, and a computer readable recording medium for charging for an on-line advertisement. In the system, method, and computer readable recording medium, an advertisement cost may be determined based on an advertisement unit price or a click count by applying a balanced quality index in determining the advertisement cost for an on-line advertisement.

Additional features of the invention will be set forth in the description which follows, and in part will be apparent from the description, or may be learned by practice of the invention.

Exemplary embodiments of present invention provide a computer-implemented charging control method, including: determining an expected click count for an advertisement provided on a web page; obtaining a generated click count for the advertisement, using the computer, the generated click count including a number of clicks on the advertisement during a period of time; generating an invoice for the advertisement, based on the expected click count and the generated click count; and transmitting the invoice to an advertiser terminal.

Exemplary embodiments of the present invention provide an advertisement system, including: an advertisement providing unit to provide an advertisement to a web page; an advertisement selection information processing unit to obtain a generated click count including a number of clicks on the advertisement during a time period; and a charging processing unit including a processor to determine an expected click count of the advertisement for the time period, based on a position the advertisement is displayed in the web page, and to determine a charged amount for the advertisement based on the expected click count and the generated click count.

Exemplary embodiments of the present invention provide a non-transitory computer-readable recording medium including an executable instructions, which when executed, determines an expected click count for an advertisement provided on a web page; obtains a generated click count for the advertisement, the generated click count including a number of clicks on the advertisement during a period of time; generates an invoice for the advertisement, based on the expected click count and the generated click count; and transmits the invoice to an advertiser terminal.

Exemplary embodiments of the present invention provide a charging control method, including: obtaining an expected click count for an advertisement, based on a display position of the advertisement in a web page and a number of competing advertisements displayed in the web page; obtaining a generated click count of the advertisement, the generated click count including a number of clicks on the advertisement during a period of time; and determining a charged amount for the advertisement based on the expected click count and the generated click count.

Exemplary embodiments of the present invention provide a computer-implemented charging control method, including: determining an expected click count for an advertisement provided on a web page; obtaining a generated click count for the advertisement, using the computer, the generated click count including a number of clicks on the advertisement during a period of time; generating an invoice for the advertisement, based on the expected click count and the generated click count; and transmitting the invoice to an advertiser terminal, wherein the invoice is generated based on a balanced quality index (QI) that is a reciprocal of a performance factor (PF) represented by the following equation:

$$P F = 1 - \frac{{\sum }_{d = 1}^{n} {UCC}_{d} {PF}_{d - 1} - {\sum }_{d = 1}^{n} {ECC}_{d}}{ave ( E C C )} ,$$

wherein ‘n’ is a number representing an accumulated days, UCCd is a utility click count for a day ‘d’, ECCd is an expected click count for the day ‘d’, PFd−1 is a performance factor for a day ‘d−1’, ave(ECC) is an average of expected click counts for the ‘n’ days.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram showing a schematic configuration of an advertisement system, according to an exemplary embodiment of the present invention.

FIG. 2 is a diagram showing a charging method of an advertisement system, according to an exemplary embodiment of the present invention.

FIG. 3 and FIG. 4 show equations for calculating a balanced quality index, according to an exemplary embodiment of the present invention.

FIG. 5 is a diagram showing a CCR table to determine an expected click ratio for each of ranked areas, according to an exemplary embodiment of the present invention.

FIG. 6 is a table showing an example of calculating a balanced quality index, according to an exemplary embodiment of the present invention.

FIG. 7 is a graph showing a case in which loss due to invalid clicks is offset by applying a balanced quality index, according to an exemplary embodiment of the present invention.

FIG. 8 is a flowchart illustrating a charging control method of an advertisement system, according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

In the present description, charging may refer to a process for generating charging data, including a charging procedure, a charging price, basic charging data, or the like, for charging an advertiser for providing an advertiser an advertisement publication or exposure. Particularly, the charging described in the present description should be interpreted in the widest sense, including all of various aspects of charging methods including a cost per click (CPC) method, in which an advertisement cost is calculated according to the number of selections (for example, clicks of advertisement information on an advertisement list published for a search advertisement by the users) of an advertisement by users, such as web contents users, and web surfers.

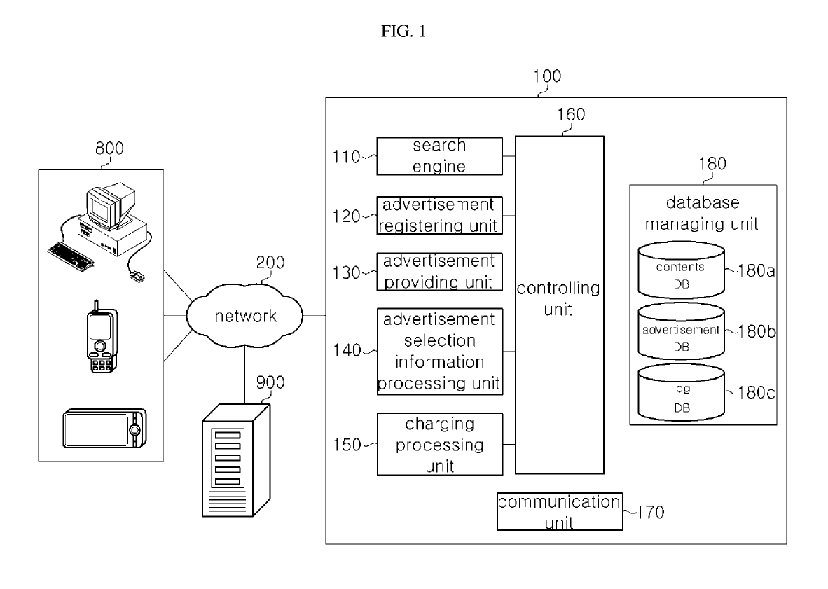

FIG. 1 is a diagram showing a schematic configuration of an advertisement system 100, according to an exemplary embodiment of the present invention. Referring to FIG. 1, the advertisement system 100 performing the advertisement service is connected to a user terminal 800, and an advertiser terminal 900 via a communication network 200.

The user terminal 800 may be various digital devices providing an Internet access function to Internet users to surf the Internet. The Internet users may search for and inquire about various products, services, and/or information while surfing on the Internet through the user terminal 800. The Internet users may access the advertisement system 100 or a publishing system (not shown) associated with the advertisement system 100, to view various advertisements provided on the Internet by the advertisement system 100 or the publishing system. In addition, the Internet users may select (for example, click) the various advertisements provided on the Internet to access an Internet address linked to the corresponding advertisement, and to purchase various products, which are objects of the corresponding advertisement.

The advertiser terminal 900 may be various digital devices capable of performing communication with the advertisement system 100, so as to receive information associated with the charging from the advertisement system 100, and to transmit data to the advertisement system 100 based on inputs of the advertiser for the corresponding charging. The advertiser terminal 900 may be one of the user terminals 800. However, the present invention is not limited thereto. The user terminal 800 may be capable of accessing the advertisement system 100 or the publishing system associated with the advertising system 100 through a public network, such as the Internet. The advertiser terminal 900 may access the advertisement system 100 through any communication network capable of performing communication with the advertisement system 100, rather than the Internet. Further, the advertiser terminal 900 may have an Internet access function to communicate with the advertisement system. Furthermore, the advertiser terminal 900 may be various digital devices capable of performing communication with the advertisement system 100, so that the advertisers who request advertisements on the Internet may access the advertisement system 100, to request advertisements and use the advertisement service provided by the advertisement system 100. Further, the advertiser terminal 900 may be a system in which various digital devices are linked together to communicate with the advertisement system 100.

Therefore, the user terminal 800 and the advertiser terminal 900 may be implemented as one or more digital devices including a memory unit and a microprocessor to process computational operations, such as a personal computer (for example, a desktop computer, a notebook computer, a tablet computer, a palmtop computer, and the like.), a workstation, a personal digital assistance (PDA), a web pad, a cellular phone, and the like. Further, the user terminal 800 and the advertiser terminal 900 may be a system having the one or more digital devices.

The communication network 200 is a network supporting the communication among the advertisement system 100, the user terminal 800, and the advertiser terminal 900 shown in FIG. 1. A configuration of the communication network 200 may be based on any communication technology that enables communications among the advertisement system 100, the user terminal 800, and the advertiser terminal 900 sufficient to implement the communication network 200. The communication network 200 may be a communication network, such as a wired communication network, a wireless communication network, and the like. The communication network 200 may also be configured based on any kind of communication technology enabling information to be exchanged among the advertisement system 100, the user terminal 800, and the advertiser terminal 900. In addition, various security-related technologies for reliability and security of an information exchange process may be applied to the communication network 200.

The advertisement system 100 may receive information on providing conditions of an advertisement from an advertiser through a communication device, i.e., the advertiser terminal 900. However, the present invention is not limited thereto. The information on the providing conditions of the advertisement may be input from the advertiser through communication devices other than the advertiser terminal 900, and the advertiser terminal 900 may be used for receiving information associated with charging from the advertisement system 100 and transmitting an input of the advertiser for the corresponding charging to the advertisement system 100.

The advertisement system 100 may receive a keyword associated with the corresponding advertisement, targeting information for the users to which the advertisement is exposed, information on a limitation of an advertisement exposure, title and description (T&D) information of the advertisement to be provided to the users, and the like, from the advertiser, prior to providing the advertisement to the user terminal 800. The above-mentioned information input through the advertiser terminal 900 may be utilized as an exposure reference of the advertisement, as in a bid-based search keyword advertisement. In addition, a bid amount (BA) may be input and may be used as basic data for advertisement position arrangement among multiple advertisements, for a corresponding search keyword and/or a calculation of an advertisement charging amount (“charged amount”). The bid amount input by the advertiser may be used for calculating an advertisement publication cost.

The advertiser system 100 may provide the advertisement to the user terminal 800. The provision of the advertisement may include exposing a corresponding advertisement on an Internet space, so that Internet users visiting the Internet space using the user terminal 800 may view the corresponding advertisement through a display, i.e., web browsing, of the user terminal 800, or by providing an advertisement according to a request by the user terminal 800.

A form of providing the advertisement to the user terminal 800 may be implemented in various ways for an advertisement service. Advertisement service methods in various forms, such as a search keyword advertisement search through a matching between a search keyword and an advertiser specifying keyword, a contextual advertisement provided while being included in contents provided to the user terminal 800, a banner advertisement in which regional targeting information is used, and the like, may be used. An online advertisement such as the search keyword advertisement, the contextual advertisement, the banner advertisement with a targeting option, and the like, are known to those skilled in the art. Therefore, a detailed description thereof will be omitted.

The advertisement system 100 may perform a content service (for example, an online search service and a news providing service) accompanied by the provision of the advertisement. Further, a publishing system may provide the content service during in the provision of the advertisement, thereby enticing users.

As described above, although not shown in FIG. 1, a separate publishing system may be involved in the provision of the advertisement. For example, if a user of the user terminal 800 visits a search engine site to input a query, a search advertisement associated with the corresponding query may be provided in a search result page provided to the user terminal 800.

This search advertisement may be provided in a form included in the search result page by the advertisement system 100. However, all of the functions associated with the search result page need not be supported by the advertisement system 100. That is, a portion of the functions associated with the search result page may be performed by a system other than the advertisement system 100.

The system providing the search result page as a response to the query of the user terminal 800 may be a search engine system configured separately from the advertisement system 100. The advertisement system 100 may receive advertisement providing request from the search engine system and provide the advertisement associated with the query input from the user terminal 800. The advertisement may be provided in a form included in the search result page.

In the advertisement providing form, the search engine system generates a page publishing (displaying) the advertisement. Therefore, the search engine system may be referred to as a publishing system for the corresponding advertisement.

Other publishing systems, such as a news site providing system, a blog hosting system, and the like, may provide the advertisement to the user terminal 800, through communication with the advertisement system 100.

The publishing systems providing contents, such as news articles or blog posting, to the user terminal 800 may request the advertisement system 100 to provide the advertisement associated with the contents. In response to the request, the advertisement system 100 may provide the advertisement information to the publishing systems. The advertisement information may be provided to the user terminal 800 through a partial area of a contents providing web page.

That is, the contents and the advertisement provided to the user terminal 800 through a single contents providing page may be controlled by multiple systems. With respect to matching between the content and the advertisement, technologies associated with the known contextual advertisement and keyword advertisement may be used. Therefore, a detailed description thereof will be omitted.

Meanwhile, if the publishing system is used in the provision of the advertisement, historical information on reactions of users for the provided advertisement, i.e., clicks on the advertisement, may be collected by the publishing system and may be transferred to the advertisement system 100, or may be collected by the advertisement system 100.

Further, the advertisement system 100 may also receive information on one or more keywords for which the advertiser wants to publish the advertisement, if the advertisement system 100 receives a request associated with a provision of the advertisement from the advertiser terminal 900. For example, if the advertiser is a flower delivery service enterprise, the one or more keywords may be “flower delivery”, “flower basket”, “memorial day”, “congratulatory gift”, and the like.

The advertisement system 100 may publish the advertisement information for exposing information of the advertiser, i.e., a web page of the advertiser, on a product selling page, if a user of the user terminal 800 inputs any one of the keywords received by the advertiser. Further, the advertisement system 100 may define one or more search keywords for publishing the advertisement information of the advertiser based on information of the advertiser, such as a business type, a business scale, an advertisement budget of the advertiser requesting the provision of the advertisement.

The advertisement provided by the advertisement system 100 may be provided to the user terminal 800, through a web page controlled by the advertisement system 100 or a web page controlled by a separate publisher system (not shown).

The advertisement system 100 may include a search engine 110, an advertisement registering unit 120, an advertisement providing unit 130, an advertisement selection information processing unit 140, a charging processing unit 150, a controlling unit 160, a communication unit 170, and a database managing unit 180. Although the components of the advertisement system 100 are shown as being implemented in a single device in FIG. 1, the present invention is not limited thereto. Each of the components may be implemented in separate systems and may perform data processing through communication therebetween.

Further, at least some of the search engine 110, the advertisement registering unit 120, the advertisement providing unit 130, the advertisement selection information processing unit 140, the charging processing unit 150, the controlling unit 160, the communication unit 170, and the database managing unit 180 may be implemented as program modules communicating with the user terminal 800 and/or the advertiser terminal 900 and/or physical devices executing these program modules. These program modules may be included in a form of an operating system, an application program module and other program module in the advertisement system 100, and be physically stored in one or more storage devices. In addition, these program modules may also be stored in a remote storage device capable of communicating with the advertisement system 100. Further, these program modules may include a routine, a sub-routine, a program, an object, a component, a data structure, or the like, performing a specific task or a method or executing a specific abstract data type to be described below; however, it is not limited thereto.

The advertisement system 100 may communicate with the user terminal 800 and/or the advertiser terminal 900 through the communication network 200, register and publish an advertisement according to a request from the advertiser terminal 900, and charge the advertiser for the advertisement if the advertisement is provided to the user terminal 800 according to selection of the user.

Further, the advertisement system 100 may be included in an operating server of an Internet portal site performing a search advertisement, a display advertisement, and the like.

The search engine 110 may crawl a web document (in the present description, the web document may referred to as data, such as a text, an image, a moving picture, an audio, and the like, or digital data formed by combining at least two of them) stored in a remote computer connected to the communication network, store information on the crawled web document in a contents database 180a, and provide the web document to a user according to a request by the user terminal 800.

The advertisement registering unit 120 may store data, such as a text, an image, a moving picture, an audio, and the like, which is specified and/or selected by the advertiser, according to the request by the advertiser terminal 900 and an advertisement formed by at least one of a text, an image, a moving picture, an audio, and the like as advertisement data in an advertisement database 180b. The contents database 180a and the advertisement database 180b will be described below in more detail.

In addition, the advertisement registering unit 120 may provide an interface, such as an online advertisement bid tool, to the advertiser terminal 900 for an advertiser to register the advertisement. For a keyword search advertisement, one or more operations supporting the bid for the advertiser may be provided by the advertisement registering unit 120. The advertisement registering unit 120 may store a portion of or all the information on an advertisement registration of the advertiser through communication with the database managing unit 180.

The advertisement providing unit 130 may receive a user input inputted to the search engine 110, such as a search keyword, and the like, search for advertisement data matched to the user input from the advertisement database 180b, and insert the advertisement information (for example, including a uniform resource locator (URL) of a web page including the advertisement data or a single line advertisement message, or the like) representing at least a portion of the searched advertisement data into the web document to be provided to the user. If the user specifies the advertisement by an action, such as selecting the advertisement information inserted into the web document, the user terminal 800 may be directly or indirectly connected to the advertiser terminal 900 by a program code inserted into the web document. The advertisement providing unit may insert the program code into the web document.

The advertisement providing unit 130 may also provide an advertisement with a search result as a response to the search keyword as well as an advertisement, such as a banner advertisement. If the separate publishing system is involved in the provision of the advertisement, the advertisement providing unit 130 may control the advertisement listing provided as a portion of the search result without configuring or controlling all contents provided to the user terminal 800.

The advertisement selection information processing unit 140 obtains advertisement selection information generated for each of advertisements after the advertisements are exposed. The advertisement selection information may include click counts generated for each of the exposed advertisements. To this end, if an event of a selection of the advertisement, i.e., a user specifies a portion of the advertisement information provided through the user terminal 800 using a mouse, a keyboard, or an input device performing a similar function, occurs, the advertisement selection information processing unit 140 may store information of the event in a log database 180c to be described below.

If the separate publishing system is used, the advertisement selection information processing unit 140 of the advertisement system 100 may directly collect the advertisement selection information on the advertisement provided to the user (“user response information”) or receive the advertisement selection information collected by the publishing system through a determined communication protocol.

The charging processing unit 150 may charge the advertiser who registers the advertisement information by generating charging information including an advertisement cost, if the advertisement information is provided to the user terminal 800 through the advertisement system 100 and is specified by a user of the user terminal 800. For example, a charging method, such as a cost per click (CPC) method in which charging is performed if a click for the advertisement is generated, or a cost per sale (CPS) method in which charging is performed so that an advertisement cost is calculated based on the sales.

If multiple advertisements are exposed in a web page, the charging process unit 150 may determine expected click counts for each of the advertisements and determine a charged cost for each of the advertisements. The determination of the charged amount may include generating an electronic invoice according to the charged amount. The charged amount for each of the advertisements may be determined based on a charged amount for each of generated click counts obtained by the advertisement selection information processing unit 140 and based on each of the expected click counts.

The expected click counts may be determined differently according to positions at which each of the advertisements is exposed in a web page, and may be determined based on statistics for a predetermined period of time for click counts of previous advertisements associated with each of the advertisements. For example, a web page may have multiple positions that may generate different expected click counts.

The charging processing unit 150 may use a charging determining parameter to determine the charged amount based on a difference between the expected click counts and corresponding generated click counts. The difference may be represented by excess, shortage, gap (−), rate (%), or the like, between the generated click counts and the expected click counts. The charging determining parameter may be used for determining an exposure order between multiple competing advertisements and be included in an equation, for example, an equation for calculating a ranking index.

The charging processing unit 150 may determine charged click counts (clicks actually charged for) from the generated click counts (clicks actually made on a displayed advertisement for a certain period of time). The charged click counts may be click counts calculated by eliminating expected invalid clicks from the generated click counts. That is, the charged click counts may be valid click counts for charging the advertisement service. Further, the charged click counts are considered for the charging among the generated click counts. The charged click counts may be determined among the generated click counts, by applying a determining rate to determine the charged amount. The determining rate may be determined differently according to a ratio of the expected click count to the generated click counts. The determining rate may be calculated by a calculation method to make the generated click counts to be converged to the expected click counts.

The charging processing unit 150 may be configured to determine the charged click counts, so as to be in a range between a maximum click count, and a minimum click count. The expected click counts may include at least one of a click count rate and a value obtained by multiplying the click count rate to the total click counts for the multiple advertisements in a web page.

The charging processing unit 150 may use a balanced quality index (QI) as the charging determining parameter. The balanced QI will be described in more detail below.

As described above, the bid amount input by the advertiser, information on valid click counts input by the advertiser, the balanced QI of the advertisement, the previous advertisement publishing information, and the like, may be used to determine the total advertisement cost. The charging processing unit 150 calculates the total cost and updates the calculated total cost as billing information on advertiser's account, thereby performing the charging (billing) for the published advertisement.

The online advertisement may be managed by a management unit, such as a keyword unit or a campaign unit, and may be stored in the database 180b with identification information provided by the management unit. Each of the components configuring the advertisement system 100 may retrieve desired information using the identification information.

The charging processing unit 150 may determine a charging reference. The charging processing unit 150 may determine a charging reference for registered advertisement information, according to reference information, such as an advertisement product, a search keyword, a search type, and the like. Further, the charging processing unit 150 may determine the charging reference, based on a selection history (for example, the click counts for specific advertisement information) of the user for the advertisement information stored in the log database 180c.

The charging processing unit 150 may determine the charged amount. The charging processing unit 150 may aggregate the selection history for the advertisement information stored in the log database 180c, thereby calculating basic charging information. The basic charging information may include click counts of users for corresponding advertisement information, a cost per click (CPC), log data according to clicks of the users, a click through rate (CTR), and the like. The click through rate refers to the number of clicks on an advertisement divided by the number of times the advertisement is shown through the advertisement system 100.

The charging processing unit 150 may provide an advertiser interface to the advertiser terminal 900. Further, the charging processing unit 150 may provide the basic charging information and/or information on the selection history for the advertisement information stored in the log database 180c to the advertiser terminal 900.

The charging processing unit 150 may perform a process for payment. Further, the charging processing unit 150 may provide an interface to the advertiser terminal 900 allowing the advertiser to pay a cost required for the advertisement. However, it is not limited thereto. The payment processing function may be selectively implemented and be thus omitted.

The controlling unit 160 may control data flow among the search engine 110, the advertisement registering unit 120, the advertisement providing unit 130, the advertisement selection information processing unit 140, the charging processing unit 150, the communication unit 170, and the database managing unit 180.

The communication unit 170 may communicate with external devices, such as the user terminal 800, the advertiser terminal 900, and the like.

The database managing unit 180 may include the contents database 180a, in which information on a web document located by the search engine 110 is stored, the advertisement database 180b, in which data on an advertisement registered by an advertiser is stored, the log database 180c, in which selection history of users for each piece of advertisement information is stored, and the like.

For example, the contents database 180a may include identification information of the web document, collection data of the web document, such as collection time of the web document, a title of the web document, abstract information of the web document, attribute information of the web document, and the like. The attribute information of the web document, which is information representing the attributes of each of the web documents stored in the contents database 180a, may include, i.e., an identifier of the advertisement information to be combined with each of the web documents, a type of an advertisement, a main keyword, and the like. If the search engine 110 crawls the web document and then analyzes it to extract the information, such as a main text, the attribute information of the web document may be determined based on the extracted information.

The advertisement database 180b may include identification information of the advertisement, advertiser identification information, information on a publication period of the advertisement, a charged amount per click of the advertisement, advertisement information to be combined with the web document, and the like. The advertisement information to be combined with the web document may include a URL representing the advertiser terminal 900 or the single line advertisement message as described above.

The log database 180c may store identification information of an advertisement selected by the user, identification information of the user who selects the advertisement, identification information of the user terminal 800, time information at which the advertisement is selected, identification information of a web document into which the advertisement is inserted, and the like.

Although the database managing unit 180 is classified into three databases, that is, the contents database 180a, the advertisement database 180b, and the log database 180c, a configuration of the database managing unit 180 is not limited thereto.

The databases included in the database managing unit 180 may be databases in a broad sense including data record based on computer file system, as well as a database in a narrow sense. Further, even a set of simple operational processing logs may be one type of the databases if it may be searched to extract data included therein.

Hereinafter, aspects of the present invention provide an advertisement system 100 that performs a charging based on a CPC type charging method. However, the advertisement system 100 is not limited thereto, but may also be applied to a system based on a CPS type charging method.

Further, the advertisement system 100 may provide a web document including at least one advertisement area to the user terminal 800 in response to a search query or an inquiry request by the user. Each advertisement area may include at least one piece of advertisement information. In addition, the advertisement information included in each advertisement area may be disposed in the advertisement area according to a determined rule. Further, advertisement costs may be differentiated according to the position in the advertisement area at which the advertisement information is disposed. For example, the advertisement cost may be determined to be higher for an advertisement positioned in the upper portion of the advertisement area than for an advertisement positioned in the relatively lower portion of the advertisement area. In addition, different advertisement costs may be charged even for advertisements disposed at the same position in the same advertisement area according to an attribute of a web page linked to a corresponding advertisement. For example, a higher advertisement cost may be charged for an advertisement inserted into a web document corresponding to a search keyword more frequently adopted by users.

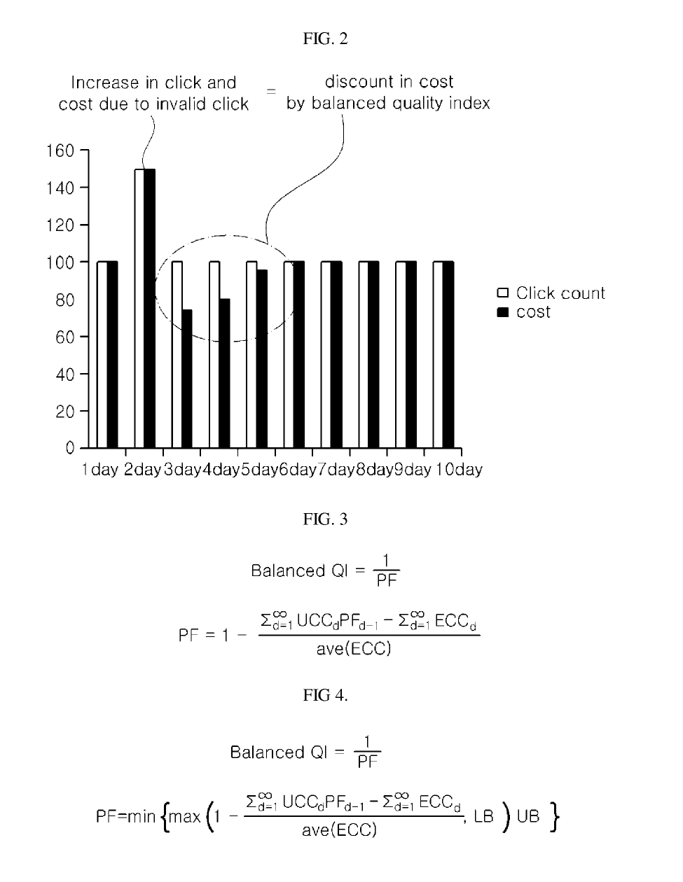

FIG. 2 is a diagram showing a charging method of an advertisement system, according to an exemplary embodiment of the present invention. The charging processing unit 150 may perform a charging using the balanced QI. Referring to FIG. 2, the charging processing unit 150 of the advertisement system 100 performs a charging process such that an increase in a charged amount due to invalid clicks and a discount in cost by the balanced QI may correspond to each other. As shown in FIG. 2, the advertisement cost for day 2 is increased due to invalid clicks; however, the increased amount of the advertisement cost on day 2 may be compensated by discounts on day 3, day 4 and day 5 using the balanced QI.

In order to assist in understanding of the balanced QI applied in the charging processing unit 150, a concept of a quality index (QI), which is a basis of the balanced QI will be described.

Generally, the QI, which is a quantified index for quality of a corresponding advertisement, may be used as an index evaluating how effectively users are tempted. The click through rate (CTR) is generally used to calculate the QI. That is, the quality of a corresponding advertisement may be evaluated according to how many click counts are generated among the total exposure counts (“the number of impressions”) by using the ratio of the total exposure counts to click counts. The balanced QI is an advanced concept, as compared to the above-mentioned QI.

For example, in a keyword search advertisement, the balanced QI may be calculated based on generated click counts with respect to expected click counts for a corresponding search advertisement. That is, the balanced QI may be calculated as a criterion for how many clicks actually occur, as compared to click counts generally expected when the advertisement is exposed in a given advertisement area. Previous expected click counts and previous valid click counts, as well as current expected click counts and current valid click counts, may be reflected in a process of calculating the balanced QI.

Further, the balanced QI may be used to calculate a rank index, together with a bid amount of the advertiser for a corresponding advertisement. In addition, the balanced QI may be reflected in an arrangement of ranks among multiple advertisements, as well as in direct representation attributes of advertisements.

The balanced QI may be used as an index reflecting reactions of users, to evaluate the quality of the advertisement and adjusting advantages and disadvantages that may be generated through invalid clicks.

The balanced QI may provide a function of the QI and a function of adjusting a balance based on expected click counts.

Further, the balanced QI may be used as an exposure rank determining factor, so that an advertisement having higher quality and higher sales contribution may be exposed in a better position. In addition, the balanced QI may be used as an index for evaluating the quality of the advertisement. With an assumption that higher the quality of an advertisement, the higher the possibility to be selected by the users, the quality of the advertisement is compared with click patterns of the users, thereby making it possible to evaluate the quality of the advertisement.

In addition, the balanced QI may be used as a factor in determining a charged amount. If a higher quality advertisement induces more clicks than expected, the advertiser may be rewarded with higher sales. The increase in click counts due to the higher quality advertisement may be determined based on the expected click counts and the generated click counts. The balanced QI serves to balance the entire advertisement costs at an expected utility level, by compensating a difference between utility clicks of the advertiser and expected click counts, based on expected utility of the advertisement system over a period of time.

FIG. 3 and FIG. 4 show equations for calculating a balanced quality index according to an exemplary embodiment of the present invention.

In the equation shown in FIG. 3 and FIG. 4, UCC refers to a utility click count, ECC refers to an expected click count, LB refers to a lower boundary, and UB refers to an upper boundary. ECC may be obtained by multiplying an expected click count rate (CCR) determined according to an exposure position by the total click counts generated by all the advertisements displayed in a page at the time of exposure.

The balanced QI may be defined as 1/PF, that is, the reciprocal of a performance factor (PF). If the users click any advertisement satisfying their search intentions or requests, the PF may be determined in comparison with the expected click counts. The PF includes a ‘quality performance element’ based on user's click patterns and a ‘value performance element’ based on valuable clicks in view of the advertisement system.

The PF includes a factor measuring performance for the quality of a corresponding advertisement and a factor measuring a gap between a value felt by the advertiser and user's click patterns according to a ratio of advertisement exposure counts to generated click counts on the assumption that a user's click counts are in proportion to the quality of an advertisement satisfying user's search intentions or requests.

Therefore, the PF may be a factor evaluating how effectively a corresponding advertisement tempts the users, by analyzing user's click patterns for a corresponding advertisement for the advertisement system. In addition, the PF may be a factor measuring how valuably a corresponding advertiser judges click counts.

The PF may be a factor in a measurement of a performance in the viewpoint of a value for a click felt by the advertiser. This is distinguished from a measurement of a performance using the quality index in the viewpoint of quality. The quality index is an index measuring how much user's search intentions or requests are satisfied by a corresponding advertisement based on user's click patterns.

The utility click count (UCC) is click counts registered and/or reported as charged click counts to the advertiser or the advertisement system 100. The UCC may be click counts judged to be valid for an advertisement effect by the advertiser among click counts obtained as an advertisement exposure result. The UCC may be obtained by a regular report reported by the advertiser at a determined time interval.

UCC_{d}*PF_{d-1}, indicates an amended utility click count (“a charged click count”) generated by amending a utility click count (capable of being determined by, for example, the advertiser or the advertisement system) through the previous day's PF. The utility click count may be amended based on the PF value of the previous day, thereby evaluating whether the utility click count determined by the advertiser or the advertisement system is appropriate.

For example, if the advertisers report a utility click count which is lower than an expected click count, penalty is provided to the advertisers through the PF to increase future charged click count as compared to the reported utility click count. If the advertisers report a utility click count which is higher than an expected utility click count, advantage is provided to the advertisers through the PF to reduce future charged click count as compared to the reported utility click count.

The PF may be used to determine whether the utility click count reported by the advertiser is appropriate to regulate the advertiser and be used to reduce a gap between a value felt by the advertiser and an expected value of the advertisement system.

UCC_{d}*PF_{d-1}=UCC_{d}/QI_{d-1}.

Meanwhile, an equation of sale may be represented as follows.

$$Sale = charging amount ( \frac{{BA}_{i + 1} X Balanced {QI}_{i + 1}}{Balanced {QI}_{i}} ) \times utility click count ( {UCC}_{d} )$$

That is, sales may be calculated by multiplying the charging amount by the utility click count. In the above equation, ‘Utility click count (UCC_{d})/Balanced QIᵢ’ may be replaced with UCC_{d}*PF_{d-1}. Here, i=d−1. Therefore, the above equation may be represented by the following equation.

$$Sale = subordinated rank index ( {BA}_{i + 1} X Balanced {QI}_{i + 1} ) \times amended utility click count ( \frac{{UCC}_{d}}{Balanced {QI}_{i}} = {UCC}_{d} X {PF}_{d - 1} )$$

In the above two equations, the subordinated rank index determines an ‘amount’ and the amended utility click count determines a ‘click count’. That is, the ‘amount’ refers to unit advertisement cost or advertisement cost per click, and the ‘click count’ refers to charged click counts. Meanwhile, the subordinated rank index corresponds to the ‘minimum cost condition for maintaining the rank’, which performs an important role determining the amount, the unit advertisement cost for the rank.

If the amended utility click count is considered as an actually chargeable click count and is used as the charged click count, the amended utility click count becomes a factor determining the sale, with an assumption that the amount is constant.

Even though the provision of the discount or penalty to the amount rather than a change in the click count is made, the mathematical result may be the same as an effect caused by the change in the click count.

Σ_{d=1}^{∞}UCC_{d}PF_{d-1} is the sum of previous click counts that has been reflected in charging for an infinite period of time. To obtain may be obtained first and then Σ_{d=1}^{∞}UCC_{d}PF_{d-1} may be obtained using statistical methods. Σ_{d=1}ⁿUCC_{d}PF_{d-1} is the sum of previous click counts that has been reflected in charging for n previous days. If ‘n’ becomes larger by collecting more data for a longer period of time, more reliable result may be obtained. To obtain statistically significant result, ‘n’ should be large enough. Confidence interval may be determined, such as 95% or 99%. If level of confidence is determined as 99%, the result may be more reliable than the result obtained when confidence interval is 95%. After determining the confidence interval, minimum ‘n’ value can be determined according to the confidence interval. For example, ‘n’ value should be larger than or equal to a constant value to have a determined confidence level. Σ_{d=1}^{∞}UCC_{d}PF_{d-1} may refer to the sum of values to be reflected in the evaluation for the quality and the value of the utility click based on the previous PF values. Further, Σ_{d=1}^{∞}UCC_{d}PF_{d-1} may be an accumulation of the click count which is used as a reference at the time of charging and is the same as the sum of the entire advertisement cost received from an advertiser for an advertisement item. Further, Σ_{d=1}ⁿUCC_{d}PF_{d-1} may be used instead of Σ_{d=1}^{∞}UCC_{d}PF_{d-1}. Σ_{d=1}ⁿUCC_{d}PF_{d-1} may be used if the number of previous days, ‘n’ is larger than or equal to a threshold value ‘N’. For example, the threshold value ‘N’ may be 365 if it is determined that data accumulated for 1 year is appropriate to be used.

The expected click count (ECC) is expected click counts that an advertisement ranked at a specific rank is expected to obtain from users for a determined period of time when the advertisement is exposed to the users. For example, if advertisement listing ‘A’ is exposed in rank 1 position of a page for a specific keyword for three hours, the ECC may be an expected click count that the advertisement listing ‘A’ may obtain and an expected click count rate (CCR) for the advertisement listing ‘A’ may be expected click count that the advertisement listing ‘A’ may obtain, as compared to the total click counts of the corresponding advertisement area for the determined period of time (three hours). That is, the CCR may be an expected click ratio of one advertisement among multiple advertisements in an advertisement area of a page, i.e., a web page. ECC may be obtained by following equation:

ECC=expected click count rate(CCR)×total click count

The total click count may be the sum of click counts obtained from the multiple advertisements in the advertisement area of the page. Since the ECC is calculated based on the total click count in the advertisement area to which the corresponding advertisement (i.e., the advertisement listing ‘A’) pertains, excessive clicks generated in a specific advertisement may not have a strong influence. Therefore, the influence of excessive clicks (“invalid clicks”) on a specific advertisement on the corresponding advertisement charging may be reduced.

Σ_{d=1}^{∞}ECC_{d} is the sum of the ECCs that is calculated for an infinite period of time. To obtain Σ_{d=1}^{∞}ECC_{d}, Σ_{d=1}ⁿECC_{d} may be obtained and then Σ_{d=1}^{∞}ECC_{d} may be obtained using the above-mentioned statistical methods. Σ_{d=1}ⁿECC_{d} is the sum of the expected click counts for ‘n’ previous days. The ‘n’ previous days may be selected in consecutive order or non-consecutive order among more than ‘n’ previous days for calculating Σ_{d=1}ⁿUCC_{d}PF_{d-1} or Σ_{d=1}ⁿ=ECC_{d}. The number ‘n’ may be larger than or equal to the threshold value ‘N’, a constant value. Further, the above-mentioned statistical methods may be used to obtain ave(ECC).

A variation of an average ECC value may be reduced by accumulating ECC values obtained every day and calculate the average ECC value over a relatively longer period time. Even though excessive clicks are generated at a specific time, the influence of the excessive clicks may be restrictive because previous values are reflected in an average value, when the balanced QI is calculated. Therefore, excessive advertisement costs due to excessive or malicious clicks may be prevented.

The ave(ECC) refers to the average ECC value. The ave(ECC) may be obtained by the following equation:

$$ave ( E C C ) = \frac{{\sum }_{d = 1}^{n} {ECC}_{d}}{n} ( for ‘ n ’ days )$$

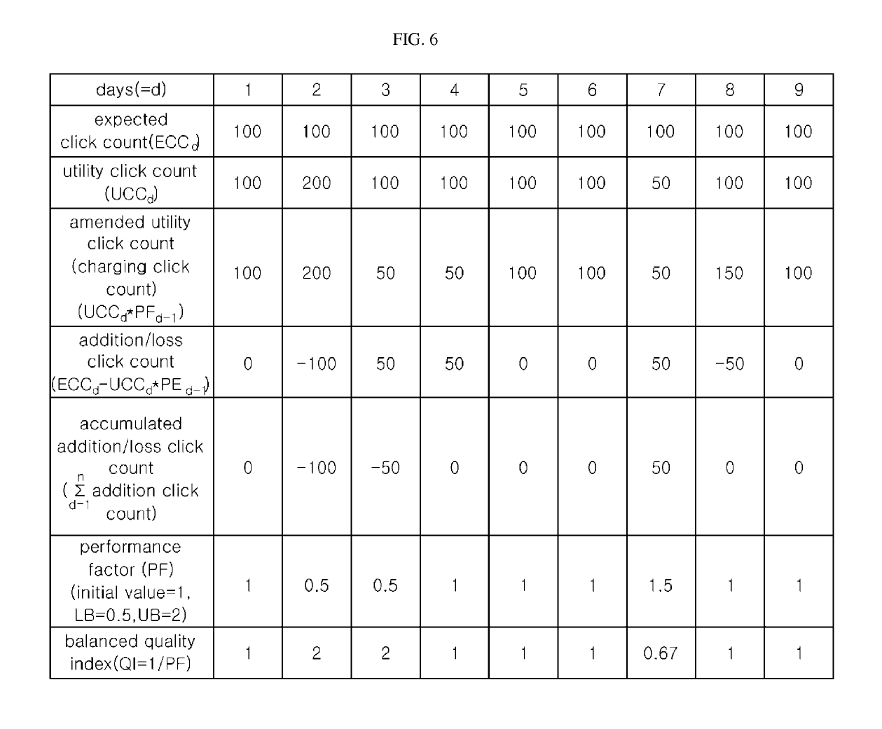

Referring FIG. 4, PF may be calculated between a lower bound and an upper bound. If a calculated PF value is smaller than the lower bound (‘LB’), the value of the lower bound (‘LB’) may be used as a PF value. If a calculated PF value is larger than the upper bound (‘UB’), the value of the upper bound (‘UB’) may be used as a PF value. Further, a charged click count or an amended utility click count may be bounded within a range between a minimum click count and a maximum click count (See FIG. 6).

The expected click count rate (CCR) may be represented by the ratio of the expected click count of an advertisement positioned at a ranked area to the total click count of multiple advertisements positioned at each of ranked areas for the same keyword. For example, all keywords are divided for each business type and the user click patterns of each business type may be used, thereby obtaining a CCR table.

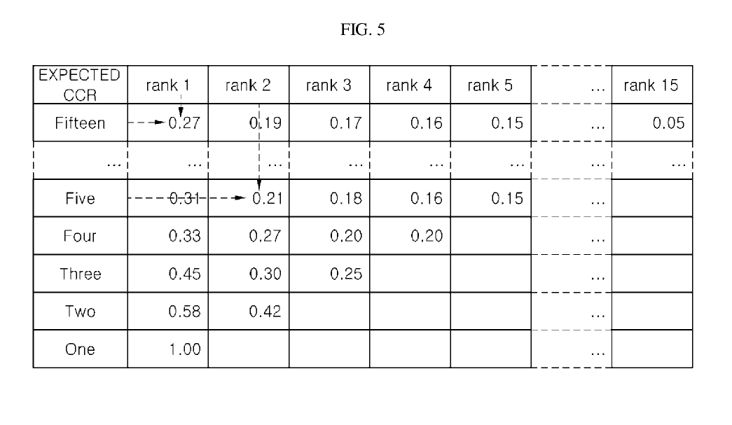

FIG. 5 is a diagram showing a CCR table to determine an expected click ratio for each of ranked areas according to an exemplary embodiment of the present invention.

Referring to FIG. 5, the charging processing unit 150 of the advertisement system 100 may use an expected click count rate (CCR) table shown in FIG. 5 to obtain an expected click count for each advertisement positioned at each of ranked areas. In the expected CCR table, an expected click count rate (CCR) of each advertisement is arranged in a table according to the number and rank of the advertisements. For example, an expected CCR of an advertisement to be exposed at a rank 1 position among fifteen advertisements may be 0.27, and an expected CCR of an advertisement to be exposed at a rank 2 position among five advertisements may be 0.21. That is, the expected CCR indicates a possibility to be clicked at the time of exposure as a numerical value. Therefore, it may be understood that the higher the expected CCR, the higher the click possibility of the corresponding advertisement by users. Meanwhile, the expected CCR may be determined using, for example, statistics on the click count according to the same type or similar type of advertisement, the number of advertisements, or positions for each rank over a certain period of time.

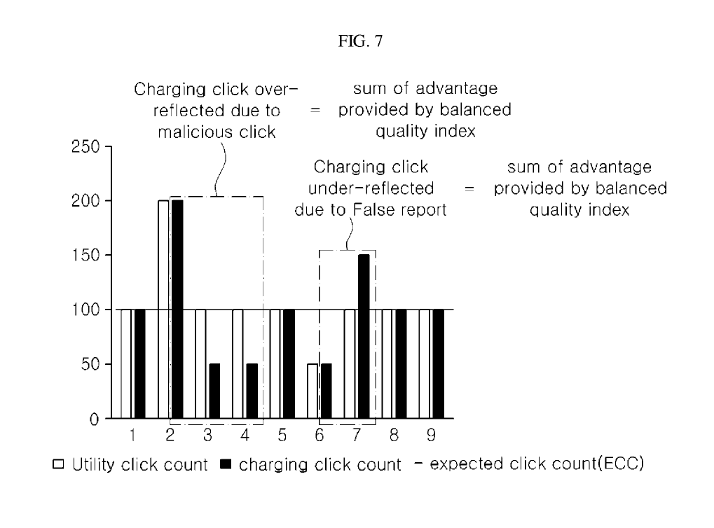

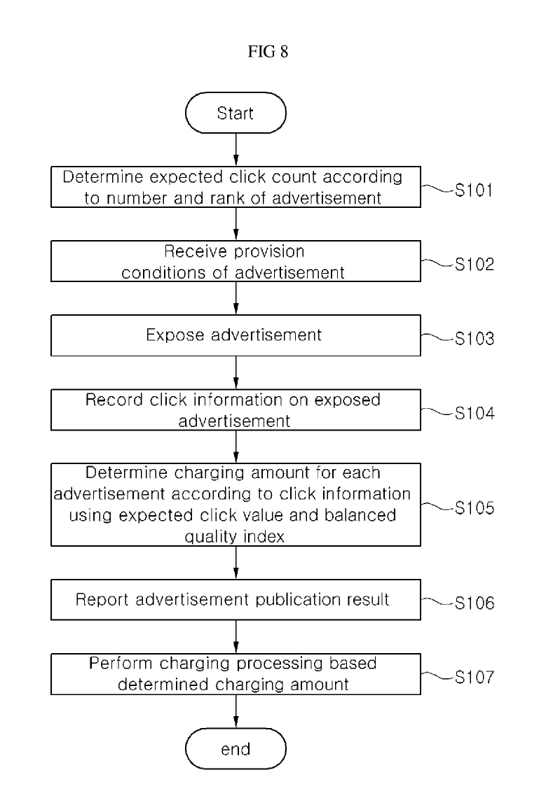

FIG. 6 is a table showing an example of calculating a balanced quality index according to an exemplary embodiment of the present invention, and FIG. 7 is a graph showing a case in which loss due to invalid clicks is offset by applying a balanced quality index according to an exemplary embodiment of the present invention.

Referring FIG. 7, a loss due to invalid clicks on day 2 may be offset on day 3 and day 4, by a charging control method using a balanced quality index. In a graph of FIG. 7, ‘□’ indicates a utility click count, ‘▪’ indicates a charging click count (“charged click count”), and “----” indicates an expected click count.

Calculations of parameters including the balanced QI will be described with reference to FIG. 6 and FIG. 7.

First, it is assumed that the expected click count calculated using the CCR table is 100 for nine days, and the ave (ECC) for the same period is also 100.

If an advertiser reports that the utility click count for the second day is 200, and the utility click count for the seventh day is 50. The changes in utility click counts may be caused by an unexpected rapid change in click count or a false report or a click fraud of the advertiser. In order to calculate PF, the initial value of the PF is set to 1, LB is set to 0.5, and UB is set to 2.

Referring to FIG. 6, if the advertiser reports relatively higher utility click count than expected click count, by generating unexpected or malicious clicks, the PF value decreases. For example, if the advertiser reports that utility click count on day 2 is 200, which is two times of the average expected utility count, the PF is reduced to 0.5, such that the charged click count for two days from the next day is reduced to a half of the utility click count reported by the advertiser. Therefore, a cost only for the click count of 50 is calculated on day 3 and day 4. The PF value will be recovered to 1 if accumulated addition/loss click count is equal to zero or within a determined range from zero. Amended utility click count may be UCC_{d}PF_{d-1}. That is, the amended utility click count for day=d is obtained by multiplying the utility click count for day=d to PF for day=d−1. Addition/loss click count may be ECC_{d}−UCC_{d}PF_{d-1}. The accumulated addition/loss click count may be Σ_{d=1}ⁿECC_{d}−UCC_{d}PF_{d-1}. The PF value is determined within a range between LB and UB. Referring to FIG. 6, LB=0.5 and UB=2

Even through the balanced QI temporally increases by the reduction of the PF, it returns to the original value ‘1’ when the accumulated addition/loss click count becomes 0, that is, for the fourth day, after two days from the second day.

Likewise, even though the advertiser intentionally reports the utility click count for the seventh day is 50, a half of the average ECC, the PF is increased such that the charged click count after one day becomes 150, which is increased as compared to the average ECC by 50%. Therefore, the accumulated addition/loss click count may be balanced to be 0.

As a result, even though the advertiser intentionally manipulates the utility click count, after a period of time elapses, the charged click count is adjusted so that the total accumulated addition/loss click count converges to zero, thereby balancing the total accumulated addition/loss click count. That is, the charged click count is balanced by the average expected click count.

In a long-term viewpoint, advertisement service sales based on the expected click count may be secured. Since the expected click count is a value in which a long-term use pattern of the user is reflected, the advertiser also needs to pay for advertisement cost based on the expected click count.

Referring to FIG. 7, the charging processing unit 150 may use the balanced QI for a charged amount calculation for the advertisement, to provide an advantage of an advertisement cost discount to an advertiser who registers a high quality advertisement that induces more than the expected number of clicks and provide a penalty of an advertisement cost premium to an advertiser who registers a low quality advertisement inducing fewer than an expected number of clicks. Thus, advantages and disadvantages due to invalid clicks may be eliminated, and it may be possible to maintain proper advertisement costs by controlling the advertisement costs from an invalid click. For example, as shown in FIG. 7, a loss of an advertiser may occur due to non-detected invalid clicks generated on the second day, and the invalid clicks increase the balanced QI for the corresponding advertisement. Therefore, advertisement costs may be discounted from the third day to fourth day, such that the loss of the advertiser generated on the second day may be compensated.

As a result, an increased advertisement cost calculated based on the charged click counts over-counted by invalid clicks, such as the malicious clicks, are the same as the sum of the advantages provided by the balanced QI. Likewise, a reduced advertisement cost calculated based on the charged click counts under-counted due to a false report, as compared to the expected click count, are the same as the sum of the penalties provided by the balanced QI. Therefore, the sum of the charged click count paid for by the advertiser becomes the same as the sum of the expected click count regardless of the intention of the advertiser. Accordingly, the gain and the loss obtained through the malicious or excessive clicks may be compensated by the balanced QI.

A “utility click” indicates a click providing utility to the advertiser after any advertisement is exposed, i.e., a click which contributes to sales of the advertiser. A determination for the utility click and a determination for the charged amount may be performed by the advertisement system 100. However, the determination for the utility click and the determination for the charged amount may be performed directly by the advertiser.

The concept of the utility click described above is associated with the balanced QI. First, describing the meaning of the ‘utility’ in the viewpoint of the advertiser, the advertiser recognizes ‘a degree of clicking and exposure’ of an advertisement provided by the advertisement system 100 as an item or a product and purchases the degree of clicking and exposure. The degree of clicking and exposure may be purchased to attract customers, to gain brand recognition, to generate a purchase induction, and to increase sales. When the advertiser spends the advertisement cost, a correlation between the corresponding exposure and incremental sales may be the most important factor. Ranking indices (ROI) showing advertisement effects, such as awareness, accessibility, inventory turnover ratio, or the like, are vital considerations for determining substantial advertisement cost expenditures. Therefore, in the viewpoint of the advertiser, the ‘utility’ indicates the exposure and the click count contributing to the advertisement effect. However, information on the advertisement effect (for example, the inventory turnover ratio, the advertisement cost, the ROI, or the like) is the result of events generated on the advertiser's web site. Therefore, since it may be difficult for the advertisement system 100 to recognize the advertisement effect, the utility click count may be determined by the advertiser.

Next, describing the meaning of the ‘utility’ in the viewpoint of an operator of the advertisement system 100, the operator of the advertisement system 100 sells a level of an ‘expected exposure and click’ according to an exposure rank for each keyword to the advertiser. This means that a value of a product is defined as the ‘expected exposure and click’. The advertiser purchases a search advertisement product provided from the advertisement system 100 because the advertiser expects users to visit the advertiser's sites more than at least a number expected from the expected exposure and click. That is, the advertiser evaluates values of products in proportion to the click count expected that users make to visit the advertiser's sites. The expected click, which is a value reflecting previous usage patterns of the users, indicates the click count of the users expected according to a search rank of the corresponding keyword.

Therefore, the operator of the advertisement system 100 may obtain the utility by the expected click count from the advertisers. The advertisement system 100 may dispose advertisements in the right places based on the quality of the advertisements to tempt the users to click the advertisements, thereby making it possible to increase a search satisfaction for the users in a short term and increase a level of the ‘expected click’ over a long term. This may generate a positive feedback increasing sales by improving the value for the ‘expected click count’.

Describing the concept of the ‘invalid click’ and the ‘addition/loss click’ in a utility viewpoint, the invalid click may refer to a click that does not have an influence on the utility of interested parties, such as the advertiser, the advertisement system, the user, or the like, as opposed to a valid click. The core of the ‘invalid click’ dispute instituted by the advertisers is that the advertisement effect is reduced, due to the invalid clicks, because the invalid clicks prematurely exhaust the limited advertisement budget, thereby causing a loss of advertisement opportunity, a loss of a sales opportunity, and/or a loss of sales.

The valid/invalid clicks may be defined with respect to a utility viewpoint of the advertiser. The valid clicks, which are clicks judged to be valid by the advertiser among the obtained click count, may be referred to as the utility click. The invalid click is a click it does not have an influence on users' recognition of a brand and a product or does not influence really inducing the purchase of the product.

The expected clicks and the addition/loss clicks will be described. The expected clicks and the addition/loss clicks may be defined with respect to utility viewpoint of the advertisement system 100. The expected clicks indicate the utility expected from the advertisement system and may be measured from usage patterns of users. The additional clicks, which is the number of valid clicks in excess of the expected number of clicks, indicates additive utility obtained due to a higher quality advertisement of the advertiser. The additional clicks may be a difference between the valid clicks and the expected clicks, when the number of the valid clicks is higher than the number of the expected clicks.

The loss click indicates loss for the utility provided by the advertisement system 100, due to a lower quality advertisement of the advertiser. The loss click may be a difference between the valid clicks and the expected clicks, when the number of the valid clicks is lower than the number of the expected clicks.

The additional utility obtained due to the higher quality advertisement returns to the advertiser in the form of the additional clicks. To the contrary, a loss is also imposed to the advertiser by the loss clicks as a penalty, thereby making it possible to secure the utility by the expected clicks over a long period of time.

FIG. 8 is a flowchart illustrating a charging control method of an advertisement system according to an exemplary embodiment of the present invention. Hereinafter, a charging control method of an advertisement system will be described with reference to FIG. 8. FIG. 8 will be described according to the process performed by the advertisement system 100 shown in FIG. 1. However, FIG. 8 is not limited as such.

Referring to FIG. 8, the charging processing unit 150 determines the expected click count, according to a position at which the advertisement is published on the cyber space (web page) in operation S101. The expected click count may also be determined using the expected CCR table described in FIG. 5.

The advertisement registering unit 120 receives provision conditions of an advertisement including a bid amount suggested from the advertiser terminal 900 in order to provide an advertisement service according to the keyword inputted by a user through the user terminal 800 in operation S102. Here, the advertisement registering unit 120 may receive information on multiple keywords with respect to the advertisement, which the advertiser wants to publish, and/or autonomously determine multiple keywords based on information on the advertiser requesting the provision of the advertisement, for example, business types, scales, advertisement budgets, and the like. The advertisement registering unit 120 may further receive targeting information on the user to which the advertisement is exposed, information on restrictions of an advertisement exposure, information on title and description (T&D) of the advertisement from the advertiser.

Further, the advertisement providing unit 130 may expose the advertisement at a determined position on the cyber space in operation S103. The advertisement selection information processing unit 140 records advertisement click information or advertisement selection information, such as clicking by a user, and the like, after receiving a keyword input from a user of the user terminal 800 through which the advertisement is published in operation S104. Here, the recorded click information may include a process of determining which action the user takes through the user terminal 800 and storing the determined result. The recorded click information may be historical information collected during an advertisement publication period.

If the advertisement publication period is designated, the advertisement selection information processing unit 140 may perform a process of recording the click information generated during the designated advertisement publication period and analyzing the corresponding click information. The advertisement selection information processing unit 140 may analyze the click information to obtain the generated click count generated for each advertisement. In addition, the advertisement selection information processing unit 140 may analyze data regarding user's action on the previously published advertisement after the designated advertisement publication period elapses. The advertisement publication period may be designated on a daily basis, on a weekly basis, on a monthly basis, on an hourly basis, etc, and be designated on a minutely basis, according to a selection of the advertiser.

The charging processing unit 150 may determine the charging amount (charged amount) for each generated click counts obtained by the advertisement selection information processing unit 140 based on the expected click count and the balanced QI in operation S105. Then, the charging processing unit 150 may provide the determined charging amount as the information on the advertisement publication result to the advertiser terminal 900 in operation S106. The information on the advertisement publication result may include various indices such as a result on the previously published advertisement, such as the exposure click count, the observed click count, the click count for each time period, and the like. Then, the charging processing unit 150 may request the advertiser terminal 900 to perform payment processing with respect to the total charging amount for the previously published advertisement or may perform charging processing using information on the advertiser's account, and the like in operation S107. Here, the charging for advertisement publication may be performed by storing information on the advertiser's account in the database 180b and changing balance information on the advertiser's account after the advertisement publishing service, thereby invoicing the advertisement publication cost.

Aspects of the present invention may be implemented in a form of program instructions capable of being performed through various computer components to be recordable in a computer-readable recording medium (“a non-transitory recording medium”). The computer-readable recording medium may include program instructions, data files, data structures, and the like or the combinations thereof. The program instructions recorded in the computer-readable recording media may be designed and constituted especially for implementing the present invention, or the type of the program instructions may be known to those skilled in a field of computer software. The computer-readable recording medium may be a magnetic medium, such as a hard disk, a floppy disk, and a magnetic tape; an optical recording medium such as a CD-ROM, a DVD, etc.; a magneto-optical medium such as a floptical disk; and a hardware device specially configured to store and perform program instructions, such as a ROM, a RAM, a flash memory, or the like. The type of the program instructions may be machine language codes that may be compiled by compilers as well as higher-level language codes capable of being executed by computers using interpreters or the like. The hardware device may be configured to be operated as one or more software modules in order to perform the process according to the present invention, and vice versa.

In aspects of the present invention, the balanced quality index is applied in determining a charged amount for the on-line advertisement, such that a cost determined in association with an advertisement amount or a click count may be determined as an objective amount.

Therefore, in the viewpoint of the advertiser, the advertisement cost may be more predictable for the advertiser, thereby making it possible to user the advertisement service with a better charging method, and in the viewpoint of the operator of the advertisement system, the operator may not be required to detect invalid (unfair) clicks.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A computer-implemented charging control method, comprising:
determining an expected click count for an advertisement provided on a web page;
obtaining a generated click count for the advertisement, using the computer, the generated click count comprising a number of clicks on the advertisement during a period of time;
generating an invoice for the advertisement, based on the expected click count and the generated click count; and
transmitting the invoice to an advertiser terminal.

2. The method of claim 1, wherein the expected click count is determined according to a position at which the advertisement is displayed in the web page.

3. The method of claim 1, wherein the expected click count is determined based on one of a previous expected click count associated with the advertisement, and a previous generated click count associated with the advertisement.

4. The method of claim 1, wherein the invoice is generated based on a charging parameter that is calculated based on a difference between the generated click count and the expected click count.

5. The method of claim 4, further comprising determining an exposure rank of the advertisement with respect to other advertisements displayed on the web page using the charging parameter.

6. The method of claim 4, wherein the generating of the invoice comprises determining a charged click count based on the charging parameter and the generated click count, and the charged click count comprises a number of clicks an advertiser is actually charged for.

7. The method of claim 6, wherein the charged click count is set to be no greater than a maximum click count and no less than a minimum click count.

8. The method of claim 4, wherein the generated click count is determined based on a utility click count that is provided by an advertiser terminal or an advertisement system, the utility click count comprising a click count reported as a charged click count.

9. The method of claim 8, wherein the charging parameter is a balanced quality index (QI) that is a reciprocal of a performance factor (PF) represented by the following equation:
$$P F = 1 - \frac{{\sum }_{d = 1}^{∞} {UCC}_{d} {PF}_{d - 1} - {\sum }_{d = 1}^{∞} {ECC}_{d}}{ave ( E C C )} ,$$
wherein UCCd is a utility click count for a day ‘d’, ECCd is an expected click count for the day ‘d’, PFd−1 is a performance factor for day a ‘d−1’, ave(ECC) is an average of expected click counts for a corresponding period of time, and the ECCd is obtained by multiplying an expected click count rate (CCR) determined by a position of the advertisement by a total click count comprising a sum of the generated click counts of all advertisements displayed on the webpage.

10. The method of claim 8, wherein the charging parameter is a balanced quality index (QI) that is a reciprocal of a performance factor (PF) represented by the following equation:
$$P F = min \{ max ( 1 - \frac{{\sum }_{d = 1}^{∞} {UCC}_{d} {PF}_{d - 1} - {\sum }_{d = 1}^{∞} {ECC}_{d}}{ave ( E C C )} , L B ) , U B \} ,$$
wherein UCCd is a utility click count for a day ‘d’, ECCd is an expected click count for the day ‘d’, PFd−1 is a performance factor for day a ‘d−1’, LB is a lower boundary, UB is an upper boundary, ave(ECC) is an average of expected click counts for a corresponding period of time, and the ECCd is obtained by multiplying an expected click count rate (CCR) determined by a position of the advertisement by a total click count comprising a sum of the generated click counts of all advertisements displayed on the webpage.

11. An advertisement system, comprising:
an advertisement providing unit to provide an advertisement to a web page;
an advertisement selection information processing unit to obtain a generated click count comprising a number of clicks on the advertisement during a time period; and
a charging processing unit comprising a processor to determine an expected click count of the advertisement for the time period, based on a position the advertisement is displayed in the web page, and to determine a charged amount for the advertisement based on the expected click count and the generated click count.

12. The advertisement system of claim 11, wherein the charging processing unit determines the expected click count based on the position the advertisement is displayed in the web page and a number of competing advertisements.

13. The advertisement system of claim 11, wherein the expected click count is determined based on at least one of a previous expected click count for the advertisement, and a previous generated click count for the advertisement.

14. The advertisement system of claim 11, wherein the charged amount is determined based on a charging parameter that is calculated based on a difference between the generated click count and the expected click count.

15. The advertisement system of claim 14, wherein the charging processing unit uses the charging parameter to determine an exposure rank of the advertisement with respect to other advertisements displayed on the web page.

16. The advertisement system of claim 14, wherein the charged amount is determined by determining a charged click count from the generated click count based on the charging parameter, the charged click count comprising a number of clicks an advertiser is actually charged for.

17. The advertisement system of claim 16, wherein the charged click count is set to be no greater than a maximum click count and no less than a minimum click count.

18. The advertisement system of claim 14, wherein the generated click count is determined based on a utility click count that is provided by an advertiser terminal or the advertisement system, the utility click count comprising a click count reported as a charged click count.

19. The advertisement system of claim 18, wherein the charging parameter is a balanced quality index (QI) that is a reciprocal of a performance factor (PF) represented by the following equation:
$$P F = 1 - \frac{{\sum }_{d = 1}^{∞} {UCC}_{d} {PF}_{d - 1} - {\sum }_{d = 1}^{∞} {ECC}_{d}}{ave ( E C C )} ,$$
wherein UCCd is a utility click count for a day ‘d’, ECCd is an expected click count for day the ‘d’, PFd−1 is a performance factor for day a ‘d−1’, ave(ECC) is an average of expected click counts for a corresponding period of time, and the ECCd is obtained by multiplying an expected click count rate (CCR) determined by the position of the advertisement by a total click count comprising a sum of the generated click counts of all advertisements displayed on the webpage.

20. The advertisement system of claim 18, wherein the charging parameter is a balanced quality index (QI) that is a reciprocal of a performance factor (PF) represented by the following equation:
$$P F = min \{ max ( 1 - \frac{{\sum }_{d = 1}^{∞} {UCC}_{d} {PF}_{d - 1} - {\sum }_{d = 1}^{∞} {ECC}_{d}}{ave ( E C C )} , L B ) , U B \} ,$$
wherein UCCd is a utility click count for a day ‘d’, ECCd is an expected click count for the day ‘d’, PFd−1 is a performance factor for day a ‘d−1’, LB is a lower boundary, UB is an upper boundary, ave(ECC) is an average of expected click counts for a corresponding period of time, and the ECCd is obtained by multiplying an expected click count rate (CCR) determined by the position of the advertisement by a total click count comprising a sum of the generated click counts of all advertisements displayed on the webpage.

21. A non-transitory computer-readable recording medium comprising an executable instructions, which when executed, performs the method of claim 1.

22. A charging control method, comprising:
obtaining an expected click count for an advertisement, based on a display position of the advertisement in a web page and a number of competing advertisements displayed in the web page;
obtaining a generated click count of the advertisement, the generated click count comprising a number of clicks on the advertisement during a period of time; and
determining a charged amount for the advertisement based on the expected click count and the generated click count.

23. The method of claim 22, wherein the charged amount is determined based on a charging parameter, the charging parameter is a balanced quality index (QI) that is a reciprocal of a performance factor (PF) represented by the following equation:
$$P F = 1 - \frac{{\sum }_{d = 1}^{n} {UCC}_{d} {PF}_{d - 1} - {\sum }_{d = 1}^{n} {ECC}_{d}}{ave ( E C C )} ,$$
wherein n is a number representing an accumulated days, UCCd is a utility click count for a day ‘d’, ECCd is an expected click count for the day ‘d’, PFd−1 is a performance factor for a day ‘d−1’ ave(ECC) is an average of expected click counts for a corresponding period of time, and the ECCd is obtained by multiplying an expected click count rate (CCR) determined by a position of the advertisement by a total click count comprising a sum of the generated click counts of all advertisements displayed on the webpage.

24. The method of claim 22, wherein the charged amount is determined based on a charging parameter, the charging parameter is a balanced quality index (QI) that is a reciprocal of a performance factor (PF) represented by the following equation:
$$P F = min \{ max ( 1 - \frac{{\sum }_{d = 1}^{n} {UCC}_{d} {PF}_{d - 1} - {\sum }_{d = 1}^{n} {ECC}_{d}}{ave ( E C C )} , L B ) , U B \} ,$$
wherein n is a number representing an accumulated days, UCCd is a utility click count for a day ‘d’, ECCd is an expected click count for the day ‘d’, PFd−1 is a performance factor for a day ‘d−1’, LB is a lower boundary, UB is an upper boundary, ave(ECC) is an average of expected click counts for a corresponding period of time, and the ECCd is obtained by multiplying an expected click count rate (CCR) determined by a position of the advertisement by a total click count comprising a sum of the generated click counts of all advertisements displayed on the webpage.

25. A computer-implemented charging control method, comprising:
determining an expected click count for an advertisement provided on a web page;
obtaining a generated click count for the advertisement, using the computer, the generated click count comprising a number of clicks on the advertisement during a period of time;
generating an invoice for the advertisement, based on the expected click count and the generated click count; and
transmitting the invoice to an advertiser terminal,
wherein the invoice is generated based on a balanced quality index (QI) that is a reciprocal of a performance factor (PF) represented by the following equation:
$$P F = 1 - \frac{{\sum }_{d = 1}^{n} {UCC}_{d} {PF}_{d - 1} - {\sum }_{d = 1}^{n} {ECC}_{d}}{ave ( E C C )} ,$$
wherein ‘n’ is a number representing an accumulated days, UCCd is a utility click count for a day ‘d’, ECCd is an expected click count for the day ‘d’, PFd−1 is a performance factor for a day ‘d−1’, ave(ECC) is an average of expected click counts for the ‘n’ days.

26. The method of claim 25, wherein the ECCd is obtained by multiplying an expected click count rate for the advertisement by a total click count comprising a sum of the generated click counts of all advertisements displayed on the webpage.
